(19) United States
(12) Patent Application Publication
(10) Pub. No.: US 2008/0192244 A1
(43) Pub. Date: Aug. 14, 2008

(54) Jewish-Law-Compliant Insect Checker and Sabbath Toothbrush

(75) Inventor: Samuel Veffer, Thornhill (CA)

Correspondence Address: THE WEBB LAW FIRM, P.C., 700 KOPPERS BUILDING, 436 SEVENTH AVENUE, PITTSBURGH, PA, 15219, US

(73) Assignee: Samuel Veffer, Thornhill (CA)

(21) Appl. No.: 12/028,349

(22) Filed: Feb. 8, 2008

Related U.S. Application Data
(60) Provisional application No. 60/900,670, filed on Feb. 9, 2007.

(51) Int. Cl. G01N 21/00; A46B 9/04

(52) U.S. Cl. 356/237.1; 15/167.1

(57) ABSTRACT

Devices for assisting in the observance of Jewish law are provided. An insect checking devise includes a light source in the form of a light board including a translucent surface powered by rechargeable batteries. Also, a toothbrush that prevents bleeding includes a handle and bristles coupled to the handle, with the bristles spaced such that water is not trapped between the bristles.

### CROSS REFERENCE TO RELATED APPLICATIONS

This application claims priority to and is a non-provisional of U.S. Provisional Application No. 60/900,670 filed Feb. 9, 2007.

### FIELD OF THE INVENTION

This invention is directed to the field of products for Jewish-law-observing consumers.

### BACKGROUND OF THE INVENTION

Observant Jews, and in particular, orthodox Jews, generally live their lives according to comprehensive and detailed Jewish legal requirements. The totality of Jewish legal requirements is typically referred to as “Halachah.” The term “Halachah” literally means “path,” and the term is used because orthodox Jews are obliged to follow the “path” required by Jewish law.

One commonly-known category of Halachah requirements relates to prohibitions on consumption of certain types of food. Food permitted to observant Jews is known as “kosher,” and laws regarding which food is permitted are referred to as the “laws of Kashruth.” Certain well-known requirements of the laws of Kashruth include the requirement to refrain from consuming pork, and the requirement to refrain from eating dairy products and meat products together. A less well-known, but very important, Kashruth prohibition is the prohibition against eating insects. According to Halachah, any insect which is large enough to be seen with the naked eye may not be eaten. This prohibition applies to insects that can be seen only with difficulty by the naked eye. Thus, it is generally accepted that any insect that is 30 microns in diameter, or greater, may not be eaten.

It will be appreciated that many of fruits and vegetables often have small insects on them that are difficult to detect with the naked eye, but which are forbidden for consumption according to Halachah. leafy vegetables such as lettuce present a particular problem, in that small insects greater in diameter than 30 microns are often present in lettuce leaves, particularly in the folds of lettuce leaves where they are hard to see. Also, because of their colour, lettuce leaves have the effect of camouflaging the small insects. To remove insects, the leaves are washed well, and are often soaked in salty water or vegetable wash to dislodge the insects from the lettuce and cause them to float to the surface. Then, to make sure that the insects have all been removed, each leaf is held. up to a bright light source so that the light comes through the leaf from behind. Because the leaf is translucent, but the insect is not, the insect can generally be seen when it is held up to the light source.

For large quantities of vegetable leaves to be checked, this method causes eye strain, and strain to the arm muscles as the lettuce leaves are held up to the light source. For this reason, in commercial settings such as restaurants, professional Kashruth inspectors use a photographic light box originally designed for inspecting photographic negatives. These boxes are typically several inches deep, with a clear glass or plastic inspection surface. Underneath the inspection surface are fluorescent light bulbs that provide the light for inspecting for insects. These light boxes are powered by electricity, typically provided by a cord that plugs into the wall.

There are a number of problems with these prior art devices. First, they are bulky, using up substantial space and being difficult to move from one place to the other. The difficulty in moving the light boxes from one place to another is caused not only by the bulkiness, but by the fact that the light box is plugged into the wall. Second, in ordinary commercial kitchens, there is a substantial amount of water present, and the risk of electric shock from the light boxes is therefore substantial. In fact, existing Kashruth supervision organizations warn their inspectors to spin dry lettuce leaves before using a prior art photographic light box to inspect the lettuce, thus lowering the risk of electric shock.

Another category of Halachah requiring observance of detailed rules relates to the Jewish Sabbath. In particular, there are a wide variety of activities prohibited to the observant Jew on the Sabbath. One such prohibition is the prohibition against wringing liquid from an absorbent material, or appearing to do so. Another prohibition is the prohibition against causing bleeding. There is also a prohibition against performing a mundane, weekday, activity on the Sabbath.

Each of these prohibitions presents a problem for an observant Jew wishing to brush his teeth on the Sabbath, particularly if he is using an ordinary, prior art, toothbrush, having nylon bristles. First, the bristles in ordinary prior art toothbrushes are spaced so closely together that water gets trapped between the bristles. When the brush is pushed against the teeth during brushing, the effect so closely resembles wringing that it is prohibited according to Halachah. Second, the nylon bristles are quite thin and sharp. Thus, for people with even mild gum disease, brushing of teeth can cause bleeding of the gums, contrary to Halachah. Third, some Jewish legal authorities maintain that brushing of the teeth with an ordinary toothbrush is a mundane, weekday 15 activity prohibited by Halachah.

### BRIEF DESCRIPTION OF THE DRAWINGS

The invention will now be illustrated by way of example only, in the attached drawings, which show the preferred embodiment of the invention, and in which:

FIG. 1A is a top view of the preferred insect checker;

FIG. 1B is an elevation view of the preferred insect checker; and

FIG. 2 shows multiple views of the preferred toothbrush.

### DETAILED DESCRIPTION OF THE PREFERRED EMBODIMENTS

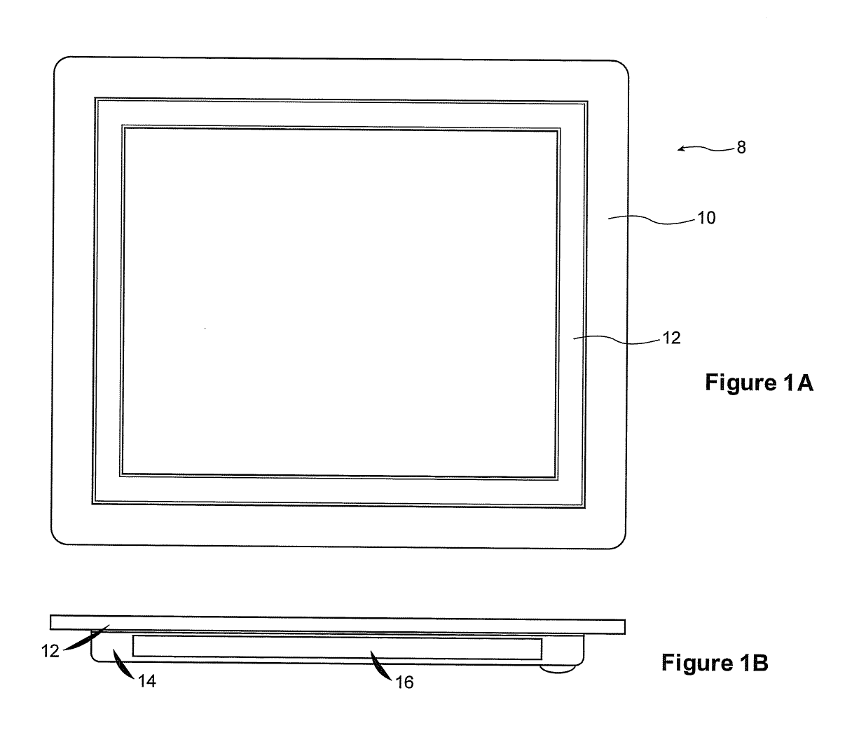

Referring now to FIGS. 1A and 1B, an insect checking device according to the present invention is shown. The device 8 comprises a light board including translucent surface 10 for transmitting light coming from within the device 8. The translucent surface 10 is preferably a generally rectangular sheet of hard glass measuring 33 centimetres by 28 centimetres, though other forms of surface 10 are comprehended by the invention. Receiving and supporting glass 8 is silica gel acetabulum 12. Beneath glass 10 is lamp system 14. Housed adjacent to the lamp system 14 is a battery box 16. The device 8 is supported by rubber feet 18. It will be appreciated that the rubber feet 18 preferably provide high friction to prevent undesired movement of the device 8. Thus, the device 8 is stable, and will typically, desirably, remain stationary during use.

Preferably, the battery box 16 contains rechargeable batteries to power the lamp system 14. The rechargeable batteries obviate the need to use a 110 volt wall plug connection, and they operate at relatively low voltage. The result is a vastly reduced risk of electrocution. Also, the rechargeable batteries do not need to be replaced, but rather, are recharged while positioned within the device 8. Thus, since the batteries do not need to be removed, they can be sealed in a water-resistant manner within the device 8. The result is that the device 8 is more resistant to possible damage from water seeping into it than it would be if the batteries needed to be removed from the device 8 to be recharged.

In addition, the lamps of lamp system 14 are preferably LED lamps. Most preferably, this LED lamp system is rated at 100,000 hours or more. The result is that the lamps rarely need to be changed, reducing operating costs and inconvenience.

Preferably, the device 8 is less than four centimetres in depth, the “depth” direction being measured orthogonally from the surface of the glass 10 toward the rubber feet 18. This compact size makes the device 8 easily portable. The device 8 is also rendered more easily portable by the use of the above-noted rechargeable batteries, which obviate the need for a wall plug, and allow the device 8 to be moved about easily.

It will now be appreciated how the device 8 can be used. The device 8 is switched on, and the rechargeable batteries provide power to the lamp system, which shines light through the glass 10. A leafy vegetable which is being checked for insects is held over the glass 10, and light through the leaf from behind, allowing the user to check if any insects are present on the leaf. The device 8 can be easily moved from one place to another within the kitchen, and there is no concern that it will become accidentally unplugged. Furthermore, the device 8 is preferably sealed in a water-resistant manner, thus reducing the risk that water will leak into the device and cause electrocution or device failure. The result is that the user of the device need not take great care to dry lettuce leaves, and may turn his attention specifically to checking for insects.

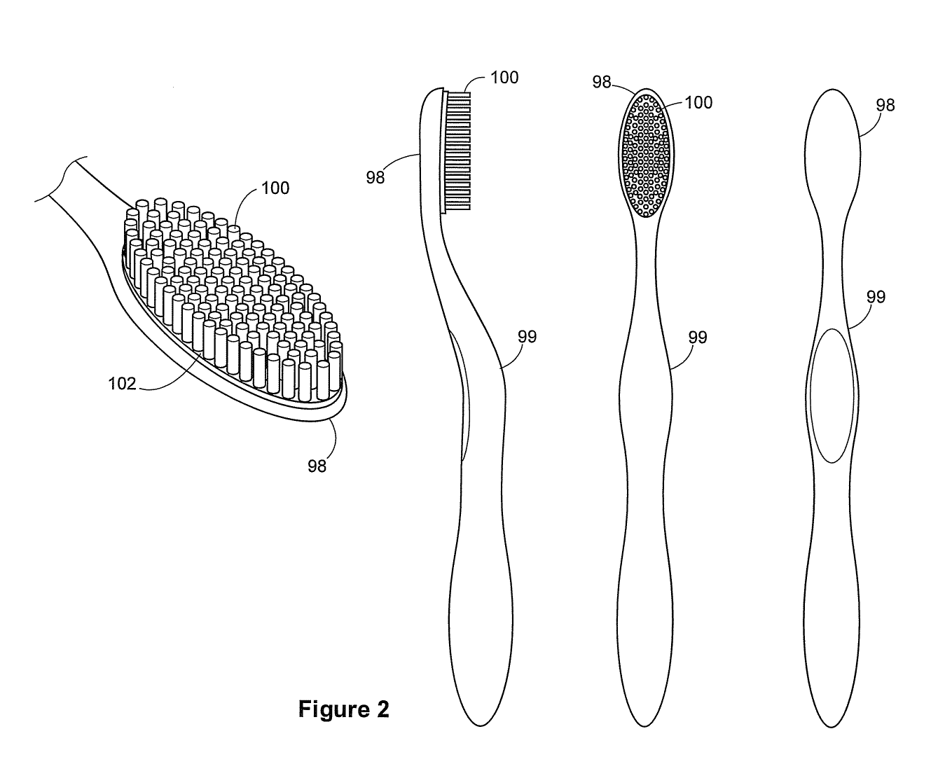

Referring to FIG. 2, a Sabbath toothbrush according to a preferred form of the present invention is shown. Bristles 100, positioned on head 98 carried by handle 99, are made of rubber, and have rounded tops to prevent the bristles from causing gum bleeding. Specifically, as the bristles are rubbery and rounded, there is no sharp end to cause bleeding.

The toothbrush also includes a central cavity 102 sized and shaped to hold liquid tooth wash. The cavity is preferably oval-shaped and 2 mm in depth, though other configurations are comprehended by the invention. One requirement of Halachah is that no spreading or smoothing of a semi-solid paste is permitted on the Sabbath. Ordinary toothpaste may therefore not be used. However, a liquid tooth wash may be used, as long as no wringing takes place or appears to take place. Therefore, the cavity 102 is shaped to receive and hold liquid tooth wash, which is then discharged onto the teeth of the user when the brush is applied to them.

The bristles 100 are also preferably spaced sufficiently apart so that liquid, by surface tension or otherwise, does not get trapped between the bristles. Since liquid does not get caught between the bristles, the toothbrush, when used, does not create the appearance of wringing liquid from between the bristles. It is for this reason, also, that liquid tooth wash may be used with the Sabbath toothbrush of the present invention.

It will be appreciated that the Sabbath toothbrush described herein also avoids the prohibition of doing a mundane activity. Because the toothbrush described herein is unusual, and is configured and designated specifically for the Sabbath, using it does not constitute a mundane or “weekday” activity. Rather, it is special Sabbath activity using an instrument designed specifically for the Sabbath.

1. The use of a light emitting device for checking food for insects, wherein the light board is powered by rechargeable batteries within the device.

2. The use as claimed in claim 1, wherein the light emitting device includes an LED light source.

3. The use as claimed in claim 1, wherein the light emitting device is 4 cm thick or less.

4. A device for checking food for insects, comprising:
(a) a light source;
(b) a translucent surface;
(c) a rechargeable battery to power the source.

5. A device as claimed in claim 4, further comprising a recharger for recharging the battery using ambient light.

6. A toothbrush for use on the Jewish Sabbath, comprising:
(a) a handle;
(b) bristles coupled to the handle; the bristles being spaced so that water contacting the bristles is not caught between the bristles.

7. The toothbrush of claim 6, wherein the bristles are composed of rubber.

8. The toothbrush of claim 6, wherein the free ends of the bristles are rounded.
